(19) United States
(12) Patent Application Publication
(10) Pub. No.: US 2005/0138568 A1
(43) Pub. Date: Jun. 23, 2005

(54) System integrated window sizing device

(75) Inventor: Michael A. Gilfix, Austin, TX (US)

Correspondence Address: BRACEWELL & PATTERSON, L.L.P., P.O. BOX 969, AUSTIN, TX, 78767-0969, US

(73) Assignee: International Business Machines Corporation

(21) Appl. No.: 10/739,517

(22) Filed: Dec. 18, 2003

(51) Int. Cl. G06F 3/00; G09G 5/00

(52) U.S. Cl. 715/788; 715/864; 715/718; 715/778; 715/851; 715/800; 715/815; 345/660; 345/161; 345/157; 345/163; 345/184

(57) ABSTRACT

A system integrated window sizing device for varying the display size of displayed windows in a portable computing device. A pointer stick device is integrated into the portable computing device and supports movement of a cursor pointer in both an X axis and Y axis direction in a first mode of operation and, in a second mode of operation can be utilized to increase or decrease a selected window size by rotation thereof. Transfer between the first mode of operation and the second mode of operation, can be accomplished by axial movement of the pointer stick.

### BACKGROUND OF THE INVENTION

1. Technical Field

The present invention relates in general to the field of input devices for communicating with portable computer devices and in particular to an integrated input device which can be utilized to both relocate a cursor pointer in an X and Y axis and efficiently resize a selected window display.

2. Description of the Related Art

Human users communicate with computers using various types of input devices, and computer systems typically include a means to communicate back to the user. The communication from a computer to the user is most commonly provided using a display screen on a device such as a cathode ray tube monitor in a full size computer system. More typically, in a portable computing device, a small liquid display or plasma display may be utilized to provide feedback to a user.

The types of input devices available to a user typically include keyboards, speech recognizers and various pointing devices such as styli, trackballs, light pens, mouse pointers or the like.

When a graphical user interface (GUI) is provided on a display screen of a computing device, these input techniques may be utilized to enable a user to interact with the graphical objects displayed therein. For example, such interaction may include selecting options, highlighting objects, moving objects and performing a variety of tasks within the computer system, with visual feedback provided by the images on the computer screen, as is well known in the art. In portable computer devices manipulation of objects within a display screen is increasingly difficult to accomplish in view of the small nature of the display provided and the fact that many input devices, such as mouse devices, trackballs or the like, are not suitable for utilization with such devices.

One device which has found great acceptance in small portable computing devices is the “TrackPoint” device which may be utilized to relocate a movable cursor within a computer display system. “TrackPoint” is a registered trademark of International Business Machines Corporation of Armonk, N.Y. A “TrackPoint”, often referred to as a pointer stick, typically resembles a small pencil eraser-like object which is integrated into a keyboard or portable computing device and, when subjected to force in an X axis or Y axis direction, translates that force into movement of a moveable cursor within the computer display system. As noted, such graphical pointing devices have found great acceptance; however, it would be advantageous to provide additional modes of operation for such devices to enhance the ability of a user to interact with graphical objects within a small display screen.

Recently, U.S. Pat. No. 6,198,472 disclosed a technique whereby an additional mode of operation may be associated with a “TrackPoint” device to provide scrolling in a three-dimensional mode. That is, scrolling in a Z axis direction in addition to the traditional X axis and Y axis direction. This technique represents a useful advance in the art of input devices within portable computing devices; however, multiple additional manipulation techniques for utilization with portable computing devices would clearly be advantageous.

### SUMMARY OF THE INVENTION

It therefore an object of the present invention to provide an improved input device for communicating with a portable computing device.

It is another object of the present invention to provide an improved input device which can be utilized to relocate a cursor pointer in an X and Y axis and efficiently resize a selected window display within a portable computer device.

The foregoing objects are achieved as is now described. A system integrated window sizing device for varying the display size of displayed windows in a portable computing device is disclosed. A pointer stick device is integrated into the portable computing device and supports movement of a cursor pointer in both an X axis and Y axis direction in a first mode of operation and, in a second mode of operation, can be utilized to increase or decrease a selected window size by rotation thereof. Transfer between the first mode of operation and the second mode of operation, can be accomplished by axial movement of the pointer stick.

### BRIEF DESCRIPTION OF THE DRAWINGS

The novel features believed to be characteristic of the invention are set forth in the appended claims. The present invention itself, however, as well as a preferred mode of use, further objectives, and advantages thereof, will best be understood by reference to the following detailed description of a preferred embodiment when read in conjunction with the accompanying drawings, wherein:

FIG. 1 is a pictorial representation of a portable computing device employing the window sizing device of the present invention;

FIG. 2 is a pictorial representation of a portable computing device of FIG. 1 after resizing a window utilizing the window resizing device of the present invention;

FIG. 3 is a graphic illustration of the control functions of the window sizing device of the present invention;

FIGS. 4A-4C depict electrical and mechanical aspects of an embodiment of the window sizing device of the present invention whereby rotation of the window sizing device controls sizing of a selected display window; and

FIG. 5 is a high level logic flow chart illustrating a process for controlling window sizing utilizing the window sizing device of the present invention.

### BRIEF DESCRIPTION OF THE PREFERRED EMBODIMENT

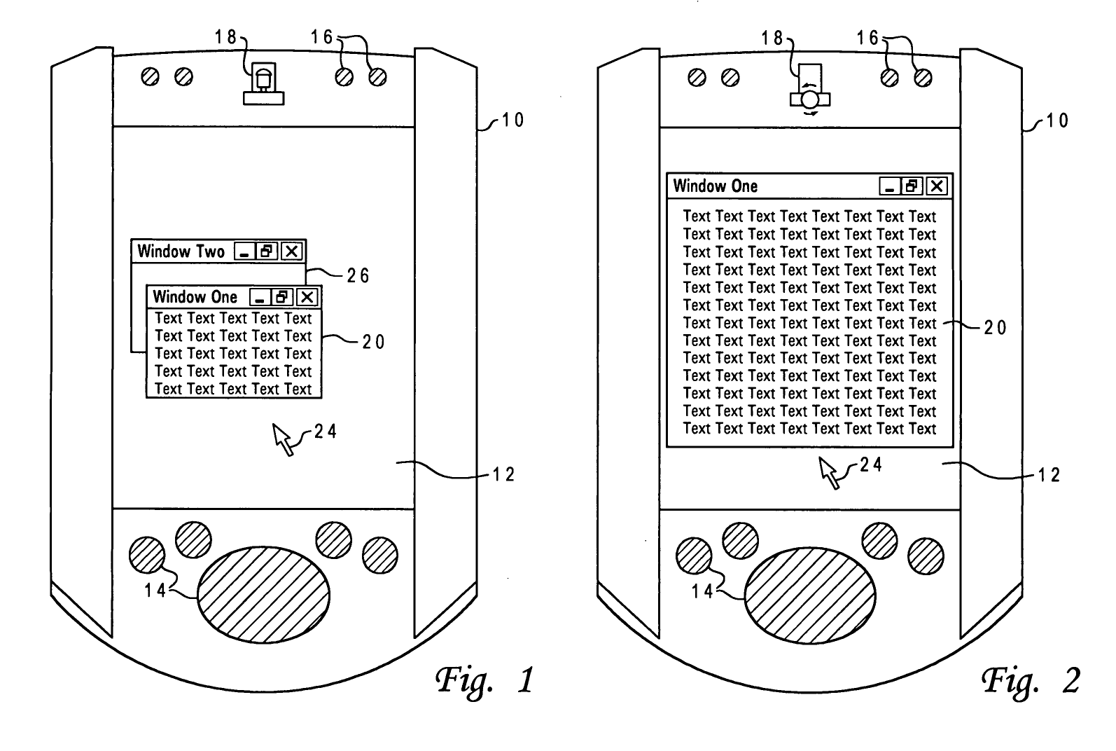

With reference now to the Figures and in particular with reference to FIG. 1, there is a pictorial representation of a portable computing device 10 which employs the window sizing device of the present invention. As illustrated, portable computing device 10 preferably includes a display screen 12 which, in the depicted embodiment of the present invention, may comprise a liquid crystal display (LCD), a plasma display or any other suitable display technology.

Also depicted within FIG. 1 are multiple selector buttons 14 which, in a manner well known to those having ordinary skill in the art, may be utilized to select particular functions within portable computing device 10. Similarly, various function buttons 16 are depicted which may be utilized to select particular functions or modes of operation within portable computing device 10.

Depicted within display 12 are multiple window displays including window display 20 and window display 26. A moveable cursor pointer 24 is also provided and, as those having ordinary skill in the art will appreciate, moveable cursor pointer 24 may be utilized to select, highlight or relocate various elements displayed within display 12 within portable computing device 10.

As those having ordinary skill in this art will appreciate a particular display window 20 or 26 may be selected and given “focus” as the window into which user inputs will be directed in a standard operating technique. Additionally, moveable cursor pointer 24 may be utilized, in well known operating systems, to resize a particular display window by relocating moveable cursor pointer 24 to one of the corners of a window and thereafter engaging in a so-called “drag” operation until the display of the window has achieved the desired size.

This particular operation is difficult to accomplish in a small portable computing device and, as a consequence the Applicants herein have provided an additional input device which may be utilized to relocate moveable cursor pointer 24 in an X axis and Y axis direction and which may be also utilized to efficiently resize a selected window display within display 12. For this purpose Applicants provide a novel variation of the well known “TrackPoint” device implemented utilizing pointer stick 18.

Referring now to FIG. 2, there is depicted a pictorial representation of portable computing device 10 of FIG. 1, after resizing window 20 utilizing the window sizing device of the present invention. As illustrated, in this depiction of portable computing device 10, pointer stick 18, which is pivotally mounted within portable computing device 10, has been rotated to an extended position and, as illustrated at reference numeral 18 may be rotated in a clockwise or counterclockwise direction when operated in a second mode of operation, as will be explained in greater detail herein. Utilizing this technique, window display 20 may be selectively increased or decreased in size without requiring intricate manipulation of moveable cursor pointer 24.

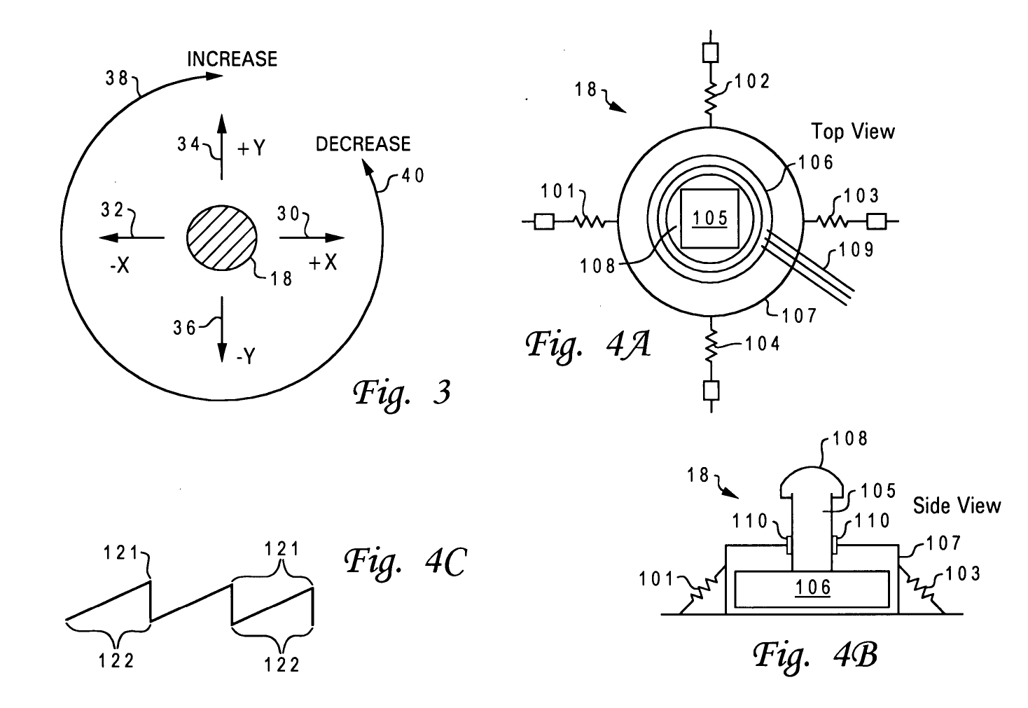

With reference now to FIG. 3, there is depicted a graphical illustration of the control functions of the window sizing device of the present invention which are available utilizing pointer stick 18. As depicted, X and Y axes are illustrated and, in response to force applied to pointer stick 18 in a left, right, up or down direction relocation of moveable cursor pointer 24 will occur (see FIG. 2) in the positive X axis direction at reference 30, the negative X axis direction at reference 32, the positive Y axis direction at reference 34 or the negative Y axis direction at reference 36, in a manner well known to those having ordinary skill in this art.

Further, when manipulated into a second mode of operation, pointer stick 18 may be utilized to efficiently increase or decrease the size of a selected display window within portable computing device 10 by rotating pointer stick 18 in a clockwise or counterclockwise direction. As illustrated in FIG. 3, a rotation in the clockwise direction, indicated at reference 38, will increase the size of a selected window display while rotation in a counterclockwise direction, indicated at reference 40, will decrease the size of the window display.

Thus, as depicted within FIG. 3, pointer stick 18 may be utilized traditionally to relocate moveable cursor pointer 24 in two dimensions or, when employed in a second mode of operation, may be utilized to increase or decrease the display size of a selected window display as will be described in greater detail herein.

Referring now to FIGS. 4A-4C, there are illustrated the mechanical and electrical aspects of one embodiment of the window sizing device of the present invention. In this depicted embodiment of the present invention, pointer stick 18 is placed into a second mode of operation by raising pointer stick 18 into an upper position by telescoping pointer stick 18 outward in an axial direction from portable computing device 10. After this mode of operation has been made available, FIG. 4A illustrates a top view of the window sizing device of the present invention. As illustrated, a base 107 is provided for pointer stick 18 which includes a continuous-turn potentiometer 106. Use of this potentiometer enables a user to continuously rotate pointer stick 18 in either a clockwise or counterclockwise direction. Connected to the top of continuous-turn potentiometer 106 is pointer stick armature 105. The top of pointer stick armature 105 preferably includes a resilient rubber tip 108.

In the depicted embodiment of the present invention armature 105 is preferably supported by bearings 110, as illustrated in the side view provided within FIG. 4B. The material composition of base 107 is preferably a flexible plastic material and, as is well known in the art, when pointer stick 18 is flexed in the X axis direction or Y axis direction, strain gages 101, 102, 103 and 104 may be utilized to measure the strength of force applied in those directions, utilizing techniques well known in the art.

Armature 105 of pointer stick 18 preferably contains a spring push-to-raise, push-to-collapse mechanism, similar to that utilized in standard retractable ballpoint pens. Thus, once the user has “popped-up” pointer stick 18, it may be rotated.

As armature 105 is rotated the resistance of potentiometer 106 is varied. This resistance may be registered utilizing electrical connections 109 and, as depicted within FIG. 4C, the resistance of potentiometer 106 increases and resets, in a saw-tooth pattern. Thus, at the beginning of a turn (0°), potentiometer 106 is at a minimum resistance 122. At the end of a turn (359°), potentiometer is at a maximum resistance 121. Each tooth in the saw-tooth wave depicted within FIG. 4C corresponds to a complete revolution of potentiometer 106 and consequently, sensing electronics may be utilized to monitor the resistance of potentiometer 106 to translate resistance increase and decrease into signals which may be utilized to increase or decrease the display size of a window display within display 12, utilizing techniques which are known to those having skill in this art.

Those having ordinary skill in this art will appreciate that pointer stick 18 may thus be utilized to relocate moveable cursor pointer 24 in either the X axis direction or Y axis direction in a manner well known in the art or, in a second mode of operation, to increase or decrease the size of a selected window display within display 12 in a highly efficient manner.

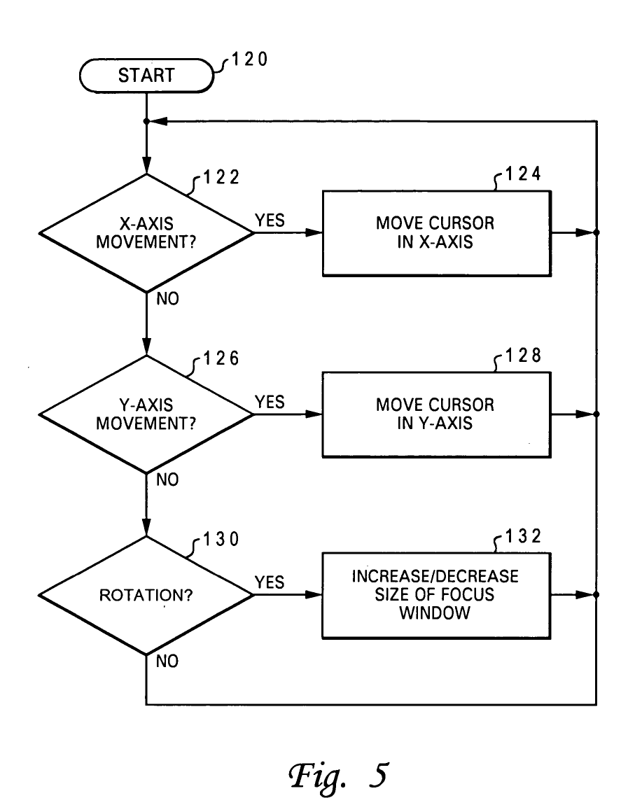

Finally, with reference to FIG. 5, there is depicted a high level logic flow chart which illustrates a process for controlling window sizing utilizing the window sizing device of the present invention. As illustrated, this process begins at step 120 and thereafter passes to step 122. Step 122 illustrates a determination of whether or not the user desires X axis movement, as indicated by force applied to pointer stick 18 in the X axis direction. If so, the process passing to block 124 which depicts the movement of the cursor in either the positive or negative X axis direction. Thereafter, the process returns to block 122, in a iterative fashion, to await further indicated movements for moveable cursor pointer 24 (see, FIG. 2).

Still referring to block 122, in the event no X axis movement is detected, the process passes to block 126 which illustrates a determination of whether or not Y axis movement has been detected. Again, movement in the Y axis is detected as a result of forces applied to pointer stick 18 in the Y axis direction. If Y axis movement is indicated, the process passes from block 126 to block 128, which illustrates the movement of the cursor in the Y axis. Thereafter, as described above, the process returns to block 122 in an iterative fashion to await further moveable cursor pointer movement indication.

Finally, in the event neither X axis movement nor Y axis movement has been detected, the process passes to block 130. Block 130 illustrates a determination of whether or not rotation of pointer stick 18 has been detected and if so, the process passes to block 132. Block 132 illustrates an increasing or decreasing of the size of the window having “focus” and, as described above, the user may therefore efficiently vary the size of a window display within a portable computing device utilizing the window sizing device of the present invention.

Finally, still referring to block 130, if no rotation has been detected, or after increasing or decreasing the size of the “focus” window, as depicted within block 132, the process returns, in an iterative fashion, to block 122 to await further controls implemented utilizing pointer stick 18.

Upon reference of the foregoing, those skilled in the art will appreciate that the Applicants in the present application have created a technique whereby one simple input device may be utilized to control movement of moveable cursor pointer in both an X axis and Y axis direction while operating in a first mode of operation and to efficiently resize a window display when operated in a second mode of operation, greatly enhancing the usability of a portable computing device having limited display capacity.

While the invention has been particularly shown and described with reference to a preferred embodiment, it will be understood by those skilled in the art that various changes in form and detail may be made therein without departing from the spirit and scope of the invention.

1. A system integrated window sizing device for resizing displayed windows in a portable computing device, said system integrated window sizing device comprising:
a pointer stick device integrated into a portable computing device;
a moveable cursor displayed within said portable computing device;
means for relocating said moveable cursor in an X axis direction and a Y axis direction in response to an application of force to said pointer stick device while in a first mode of operation; and
means for varying a display size of a selected displayed window within said portable computing device in response to rotation of said pointer stick device while said pointer stick device is in said second mode of operation.

2. The system integrated window sizing device according to claim 1, wherein rotation of said pointer stick device in a clockwise direction increases a size of a selected displayed window within said portable computing device in said second mode of operation.

3. The system integrated window sizing device according to claim 2, wherein rotation of said pointer stick device in a counterclockwise direction decreases a size of a selected displayed window within said portable computing device in said second mode of operation.

4. The system integrated window sizing device according to claim 1, further including means for initiating said second mode of operation in response to an axial movement of said pointer stick device.

5. The system integrated window sizing device according to claim 1, further including a resilient rubber tip on one end of said pointer stick device.

6. The system integrated window sizing device according to claim 1, wherein said pointer stick device pivotally mounted within said portable computing device.

7. The system integrated window sizing device according to claim 6, further including a slot receptacle within said portable computing device sized to receive said pivotally mounted pointer stick device such that said pointer stick device can be recessed into said portable computing device.
